(19) United States
(12) Patent Application Publication
(10) Pub. No.: US 2008/0261635 A1
(43) Pub. Date: Oct. 23, 2008

(54) MOBILE MESSAGING SYSTEM

(75) Inventors: Omer Samiri, Sherman Oaks, CA (US); Derek John Simms, Northridge, CA (US)

Correspondence Address: THE ECLIPSE GROUP LLP, 10605 BALBOA BLVD., SUITE 300, GRANADA HILLS, CA, 91344, US

(73) Assignee: iVisionMobile, Inc., Sherman Oaks, CA (US)

(21) Appl. No.: 12/101,386

(22) Filed: Apr. 11, 2008

Related U.S. Application Data
(60) Provisional application No. 60/923,064, filed on Apr. 12, 2007.

(51) Int. Cl. H04Q 7/20

(52) U.S. Cl. 455/466

(57) ABSTRACT

A mobile messaging campaign is established to process bidirectional mobile campaign messages associated with each of a plurality of mobile numbers using a single short code. A mobile message associated with the mobile messaging campaign is received. The received mobile message is parsed to extract a campaign identifier and the received mobile message is processed based upon the campaign identifier.

### RELATED APPLICATIONS

This application claims the benefit of U.S. Provisional Patent Application Ser. No. 60/923,064, filed Apr. 12, 2007, titled “MOBILE MESSAGING SYSTEM;” the content of which is incorporated by reference herein in its entirety.

### BACKGROUND OF THE INVENTION

1. Field of the Invention

The invention is related to a mobile message system, and in particular, a mobile messaging system that enables system users to launch and manage mobile messaging campaigns that send short message service (SMS) messages and content to users of mobile devices.

2. Related Art

Mobile marketers/interactive agencies provide interactive marketing services, such as mobile messaging campaigns, and typically work through an aggregator to provision each new mobile campaign. Conventional provisioning of mobile message campaigns is currently time consuming and costly. Short message service (SMS) messages are used for text messaging within cellular systems as part of the mobile messaging campaigns.

SMS messages use short codes for message identification. Short codes are four to six (4-6) digit mobile identifiers that are regulated and leased for mobile communication purposes. Short codes are approved by cell carriers and mobile marketing associations for message delivery identification associated with mobile marketing campaigns. Conventional mobile marketing campaigns allow for mobile marketers to establish mobile marketing activities using a single short code for each two-way messaging campaign.

### SUMMARY

The present invention relates to mobile messaging managing systems and methods that allow an account holder, i.e., system users, (“account holders” or “users”), through a messaging interface, to create different types of messaging campaigns. Messaging campaigns may be considered for purposes of the present subject matter as any mobile messaging activity where one or more mobile messages are initiated to which responses may be received in association with the initiated message(s). The various messaging campaigns may include, but are not limited to, the following: (i) mobile alert campaigns; (ii) trivia campaigns; (iii) text-to-win campaigns; (iv) text-to-vote campaigns; (v) text-to-chat campaigns; and (vi) interactive television or venue campaigns. Additionally, mobile payments and premium services are provided. The purpose of the mobile marketing campaign is to build awareness by engaging target consumers with interactive value added content sweepstakes and promotions.

Users are allowed to create both standard and premium rate campaigns. All mobile campaigns are pre-provisioned with cellular carriers to expedite setup and tear down of mobile campaigns. Users may configure campaigns using a user interface via a web site. Multiple two-way (e.g., bidirectional) messaging campaigns are established on a single shared short code. Accordingly, two unique users can have simultaneous text to vote campaigns operating on the same short code. For example, two users may have simultaneous text to vote campaigns and both may operate on a single shared short code. Further, where “A”, “B”, or “C” are potential answers, both users may operate using the single shared short code to respond with an answer choice.

A “keyword” operates as a unique campaign identifier and is sent within a mobile message to the short code associated with a mobile number to allow the user to “opt-in” to the mobile campaign. Each keyword is unique and therefore facilitates initiation of a separate mobile campaign associated with each keyword. When a user opts into a mobile campaign that is interactive, such as a text-to-vote campaign, a “reply” thread is opened for that mobile number. Subsequent incoming messages are parsed for keywords associated with open reply threads and in association with the respective mobile campaigns.

A concession ordering capability enables users to order concessions from their stadium seats using a portable device associated with a mobile number. They specify the product or service they wish to order, their seat location, and whether they want to pay cash or via mobile payment. The concession is then delivered directly to their seat.

One method includes establishing a mobile messaging campaign to process bidirectional mobile campaign messages associated with each of a plurality of mobile numbers using a single short code, receiving a mobile message associated with the mobile messaging campaign, parsing the received mobile message to extract a campaign identifier, and processing the received mobile message based upon the campaign identifier.

One system includes a mobile messaging campaign application adapted to establish a mobile messaging campaign to process bidirectional mobile campaign messages associated with each of a plurality of mobile numbers using a single short code, receive a mobile message associated with the mobile messaging campaign, parse the received mobile message to extract a campaign identifier, and process the received mobile message based upon the campaign identifier, and a processor adapted to execute the mobile messaging campaign application.

### BRIEF DESCRIPTION OF THE FIGURES

FIG. 1 is an example of one implementation of a message processing system for processing mobile messages according to the present subject matter;

FIG. 2 illustrates an example of one implementation of a messaging server for processing mobile messages within a message processing system;

FIG. 3A illustrates an example of one implementation of a first portion of a flow chart of a process for parsing and processing incoming mobile messages;

FIG. 3B illustrates an example of one implementation of a second portion of a flow chart of a process for parsing and processing incoming mobile messages;

FIG. 3C illustrates an example of one implementation of a third portion of a flow chart of a process for parsing and processing incoming mobile messages;

FIG. 4A illustrates an example of an implementation of a first portion of a flow chart of a process for message processing for a response message; and

FIG. 4B illustrates an example of an implementation of a second portion of a flow chart of a process for message processing for a response message.

### DETAILED DESCRIPTION

The present invention relates to mobile messaging managing systems and methods that allow an account holder, i.e., system users, (“account holders” or “users”), through a messaging interface, to create different types of messaging campaigns. Messaging campaigns may be considered for purposes of the present subject matter as any mobile messaging activity where one or more mobile messages are initiated to which responses may be received in association with the initiated message(s). The various messaging campaigns may include, but are not limited to, the following: (i) mobile alert campaigns; (ii) trivia campaigns; (iii) text-to-win campaigns; (iv) text-to-vote campaigns; (v) text-to-chat campaigns, and (vi) interactive television or venue campaigns. Additionally, mobile payments and premium services are provided. The purpose of the mobile marketing campaign is to build awareness by engaging target consumers with interactive value added content sweepstakes and promotions.

Users are allowed to create both standard and premium rate campaigns. All mobile campaigns are pre-provisioned with cellular carriers to expedite setup and tear down of mobile campaigns. Users may configure campaigns using a user interface via a web site. Multiple two-way (e.g., bidirectional) messaging campaigns are established on a single shared short code. Accordingly, two unique users can have simultaneous text to vote campaigns operating on the same short code. For example, two users may have simultaneous text to vote campaigns and both may operate on a single shared short code. Further, where “A”, “B”, or “C” are potential answers, both users may operate using the single shared short code to respond with an answer choice.

A “keyword” operates as a unique campaign identifier and is sent within a mobile message to the short code associated with a mobile number to allow the user to “opt-in” to the mobile campaign. Each keyword is unique and therefore facilitates initiation of a separate mobile campaign associated with each keyword. When a user opts into a mobile campaign that is interactive, such as a text-to-vote campaign, a “reply” thread is opened for that mobile number. Subsequent incoming messages are parsed for keywords associated with open reply threads and in association with the respective mobile campaigns.

A concession ordering capability enables users to order concessions from their stadium seats using a portable device associated with a mobile number. They specify the product or service they wish to order, their seat location, and whether they want to pay cash or via mobile payment. The concession is then delivered directly to their seat.

The methods and systems described guide users through the steps of developing various mobile marketing campaigns. Some marketing campaigns may be developed in as little as three steps once the system is populated with all the necessary user information, such as server information, contact information, etc. The system also allows users to manage two-way messaging campaigns. The system may further include safe guards to ensure that every mobile marketing campaign adheres to the mobile marketing association's best practice guidelines. The system may also be provisioned such that all campaign types may be utilized with all major mobile carriers.

The methods and systems described may further include a message monitoring system that allows users to view incoming messages in live mode as customers participate in mobile campaigns. The methods and systems described may allow users to poll results from a vote or trivia in real-time or search specific messages using data look-up features. The methods and systems described may also allow users to generate and build databases that can be utilized for future marketing efforts. In this manner, the methods and systems described may enable the users to create context based target lists based upon unique demographical data, among other data.

The methods and systems described may also include features that allow management of messaging campaigns, including a database management system and comprehensive reporting system. The methods and systems described may allow advertisers to distribute messages to target markets at optimal times and places to drive brand equity and traffic with instant win opportunities providing immediate gratification, expand marketing channels by adding a universal mobile response channel, and improve customer loyalty by providing a direct and on going communication channel.

Although the mobile messaging system may be employed as a web-based application, those skilled in the art will recognize that the mobile messaging system may be an application program capable of communicating with a database that resides locally or that resides remotely. Further, the mobile messaging methods and systems described may also include one module or may be comprised of a series of modules, some of which may reside local to the customer and/or user, and others of which may be accessible over a network at a remote location (e.g., via the Internet), all of which may be in communication with one another to transfer data/information. Accordingly, methods and systems described and illustrated in this application, are offered only for illustrative purposes and are not intended to limit the scope of the invention.

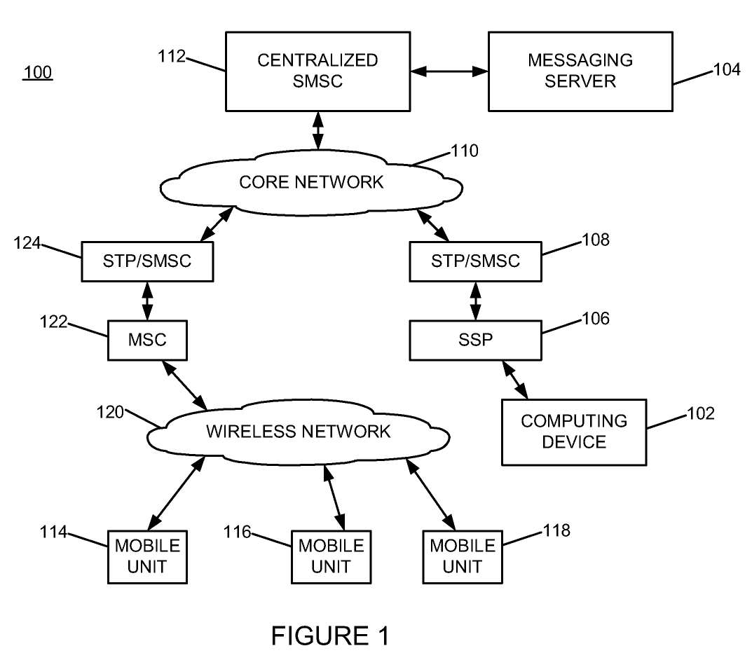

FIG. 1 is an example of one implementation of a message processing system 100 for processing mobile messages. A computing device 102 communicates with a messaging server 104 to configure and setup mobile messaging campaigns. Within the message processing system 100, a service switching point (SSP) 106, a signal transfer point/short message service center (STP/SMSC) 108, a core network 110, and a centralized SMSC 112 provide interconnectivity between the computing device 102 and the messaging server 104.

The computing device 102 interacts with the messaging server 104 via a web interface or other suitable method to enable capabilities for a mobile messaging campaign. Details of establishing and operating a mobile messaging campaign will be described in more detail below.

When a campaign has been established, configured and is operational, the message processing system 100 enables mobile devices 114, 116, and 118 to interact as participant devices within the campaign by communicating with the messaging server 104. A wireless network 120, a mobile service center (MSC) 122, and an STP/SMSC 124 enable interconnection of the wireless devices 114-118 with the core network 110 for communication with the messaging server 104.

It should be noted that many other intercommunication methods and systems are possible within the message processing system 100. Accordingly, all are considered within the scope of the present subject matter.

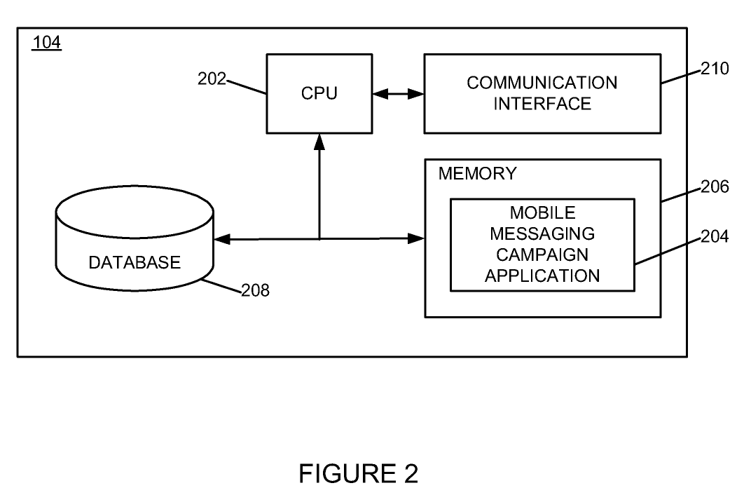

FIG. 2 illustrates an example of one implementation of the messaging server 104 for processing mobile messages within a message processing system, such as the system 100. Within the messaging server 104, a central processing unit (CPU) 202 operates to execute a mobile messaging campaign application 204 from a memory 206. The memory 206 may further include sections of volatile memory, non-volatile memory, disk storage, or other storage (not shown) without departure from the scope of the present subject matter. When executed, the mobile messaging campaign application 204 stores operational data associated with message campaigns within a database 208. A communication interface 210 facilitates interconnection with other devices within the system 100, as described above.

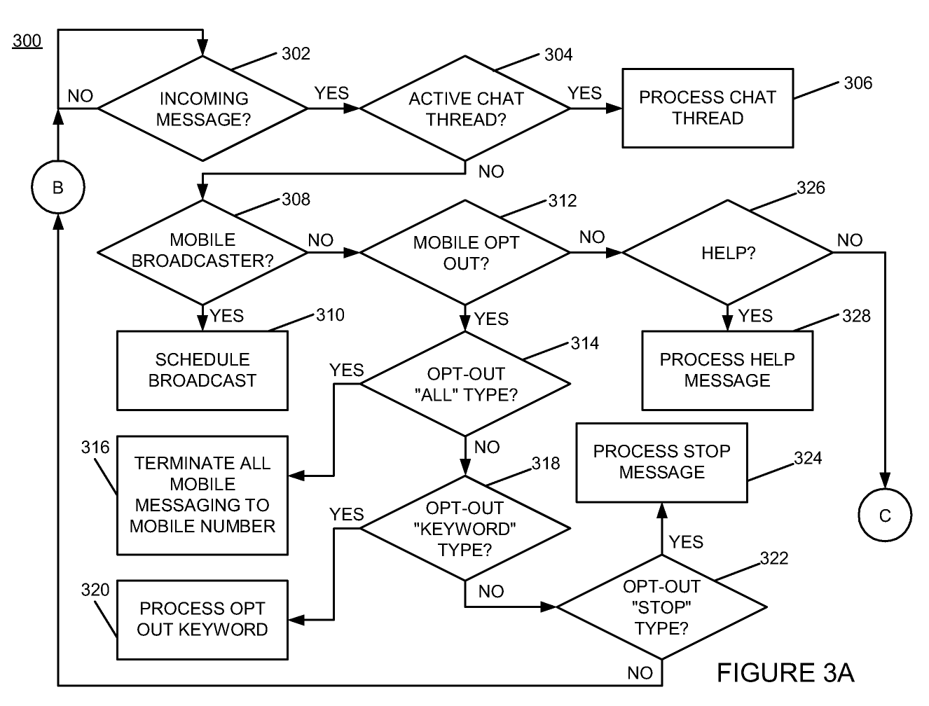

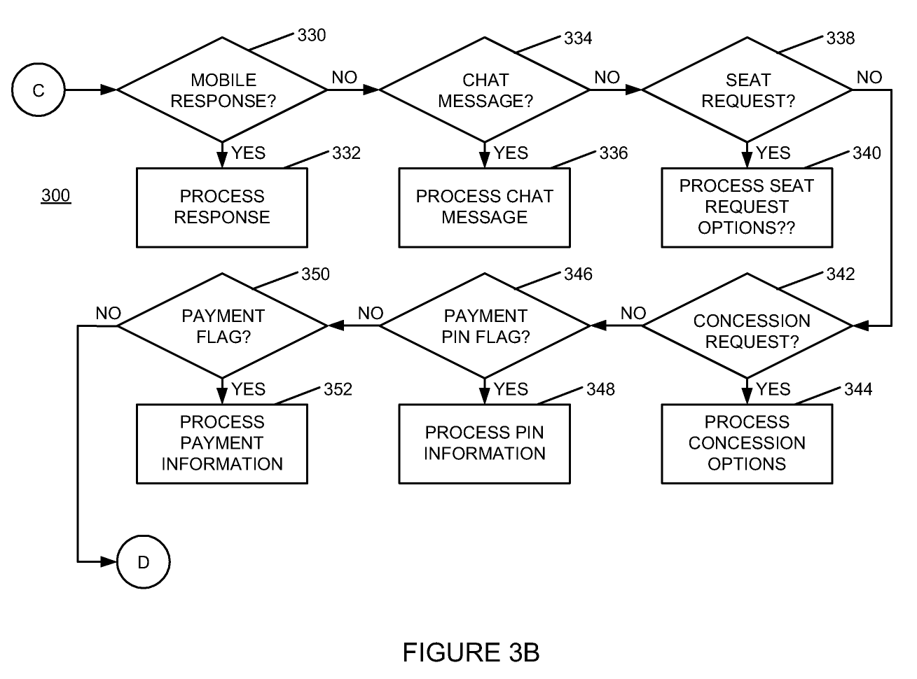

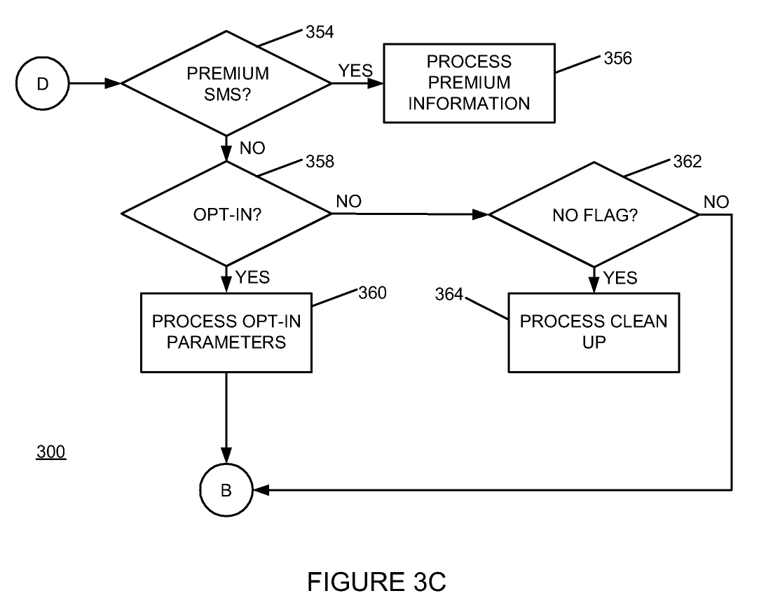

FIGS. 3A-3C illustrate an example of one implementation of a flow chart for a process 300 for parsing and processing incoming mobile messages. The process 300 may form a portion of the mobile messaging campaign application 204. It should be understood that certain of the processing steps within FIGS. 3A-3C are depicted as leaf processes without flow paths illustrated within these figures. The depiction of these processing steps as leaf processing steps is for ease of illustration purposes only and is not to be considered limiting. Any leaf processing step may perform other operations, continue to other processing steps, and return to await a new incoming mobile message as described below without departure from the scope of the present subject matter.

Referring to FIG. 3A, the process 300 waits for an incoming mobile message at decision point 302. When an incoming mobile message is detected, the process 300 begins to parse the incoming mobile message by determining whether there is an active chat thread associated with the message at decision point 304. This determination may be made by searching a database, such as the database 208, for an active chat thread associated with the originating mobile phone number associated with the message.

If an active chat thread is found within the database 208 at decision point 304, the process 300 begins to process the chat thread at block 306. Processing of the active chat thread at block 306 includes operations such as loading chat thread information and any associated campaign information from the database 208. The process further checks for an “end” command within the incoming mobile message. If an “end” command is found within the message, the process 300 ends the active chat thread. The active chat thread may be ended by storing a termination code as part of the chat thread information to the database 208 if archival of chat thread information is to be performed. Alternatively, the chat thread information and any associated campaign information may be deleted from the database 208. If an “end” command is not found within the message, the process 300 checks the source address for the chat, sends the message to the recipient mobile number, and updates the chat thread information and any associated campaign information within the database 208. Processing of the active chat thread at block 306 also includes a chat killer program that looks for and terminates any chat threads that are inactive for a configured period of time, such as chat threads with twenty (20) minutes or more of inactivity. As described above, though not depicted within FIG. 3A for ease of illustration purposes, the process 300 may return to await a new incoming message at decision point 302 after processing at block 306 is completed.

If an active chat thread is not found within the database 208 at decision point 304, the process 300 makes a determination as to whether the message is associated with a mobile broadcast at decision point 308. This determination may be made by searching the database 208 for a mobile broadcast configuration and keyword that match the originating mobile phone number and the incoming mobile message.

If a determination is made that the message is associated with a mobile broadcast at decision point 308, the process 300 retrieves associated campaign information from the database 208 and loads an outgoing mobile message into a message scheduler (not shown) at block 310. Though again not depicted within FIG. 3A for ease of illustration purposes, the process 300 may return to await a new incoming message at decision point 302 after processing at block 310 is completed.

If a determination is made that the message is not associated with a mobile broadcast at decision point 308, the process 300 makes a determination as to whether the incoming mobile message is an opt-out message type at decision point 312. This determination may be made, for example, by parsing a message type field within the incoming mobile message. The message type field may be located at a second word of the incoming mobile message.

If a determination is made that the message is an opt-out message type at decision point 312, the process 300 begins to parse the incoming message for the opt-out message type by making a determination as to whether the opt-out message type is an opt-out “all” type at decision point 314. If a determination is made that the message is an opt-out “all” type at decision point 314, the process 300 terminates all mobile messaging for the mobile phone number associated with the incoming mobile message at block 316. Termination of all mobile messaging for the mobile number may include opting the mobile number out of subscription campaigns, out of one-time campaigns, and setting an opt-out flag to “true” for the mobile number within a contacts table (not shown) stored in the database 208.

If a determination is made that the message is not an opt-out “all” type at decision point 314, the process 300 makes a determination as to whether the opt-out message type is an opt-out “keyword” type at decision point 318. If a determination is made that the message is an opt-out “keyword” type at decision point 318, the process 300 processes the opt-out keyword at block 320. Processing of the keyword includes parsing the message type field to determine whether the message type field matches any defined keywords. If a keyword match is found, the process 300 parses for a campaign type. If a campaign type is identified, the process parses the campaign type to determine the type of campaign the message is associated with. Example campaign types include, but are not limited to, “free subscription,” “premium subscription,” “one-time free,” and “one-time premium” campaign types.

If the campaign type is a free subscription campaign type, the process 300 opts the mobile number out of the subscription and sends an opt-out message to the mobile phone associated with the mobile number. If the campaign type is a premium subscription, the process 300 opts the mobile number out of the premium subscription, de-activates premium billing, and sends an opt-out message to the mobile phone associated with the mobile number. If the campaign type is a one-time free or one-time premium campaign, the process 300 opts out the mobile number and sends an opt-out message to the mobile phone associated with the mobile number. As with other leaf processing steps, the process 300 may perform additional processing and return to decision point 302 to await a new incoming message.

If a determination is made that the message is not an opt-out “keyword” type at decision point 318, the process 300 makes a determination as to whether the message is an opt-out “stop” type at decision point 322. If a determination is made that the message is an opt-out “stop” type at decision point 322, the process 300 processes the stop message at block 324. Processing at block 324 includes retrieving campaign information for the most recently sent message from the database 208. If the retrieved campaign type is a one-time free or one-time premium campaign type, the process 300 sets an opt-out flag to “true” for the mobile number in the contacts table within the database 208 and sends an opt-out message to the mobile phone associated with the mobile number. If the retrieved campaign type is a premium subscription or a free subscription, the process 300 sets the opt-out flag to “true” in the contacts table within the database 208, de-activates any billing, and sends an opt-out message to the mobile phone associated with the mobile number. The process 300 may perform additional processing and return to decision point 302 to await a new incoming message.

If a determination is made at decision point 312 that the incoming message is not a mobile opt-out message, the process 300 makes a determination as to whether the incoming mobile message is a help message at decision point 326. If the process 300 determines that the incoming mobile message is a help message, the help message is processed at block 328. Processing of the help message includes parsing the incoming message for a help identifier and also determining whether a keyword is associated with the help identifier. If a keyword is associated with the help identifier, the process 300 retrieves campaign information from the database 208 and sends a corresponding help message to the mobile phone associated with the mobile number. If the message is a “help” only message, the process 300 retrieves the campaign information for the most recently sent message and sends a help message associated with that most recently sent message.

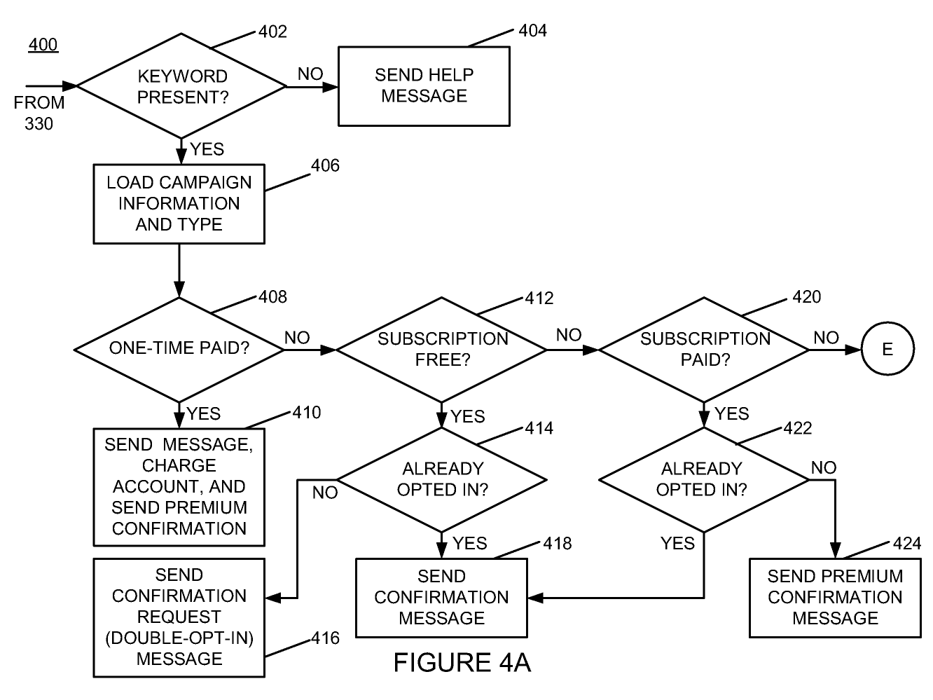

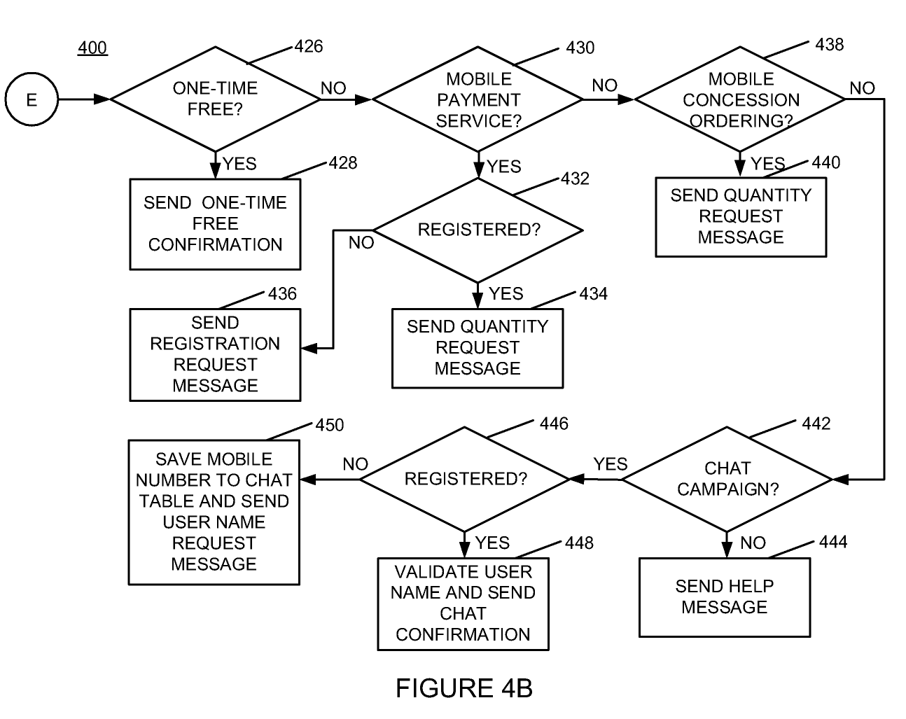

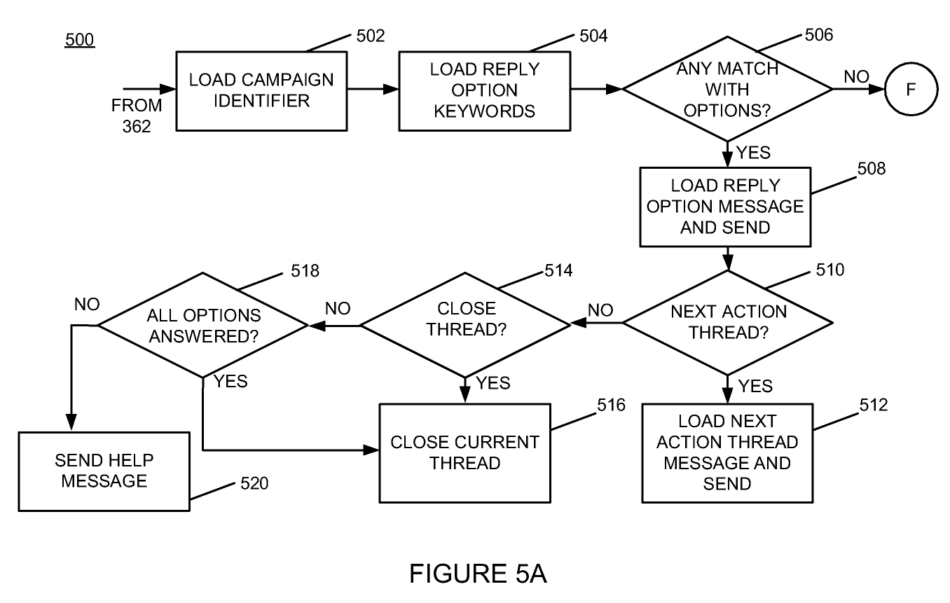

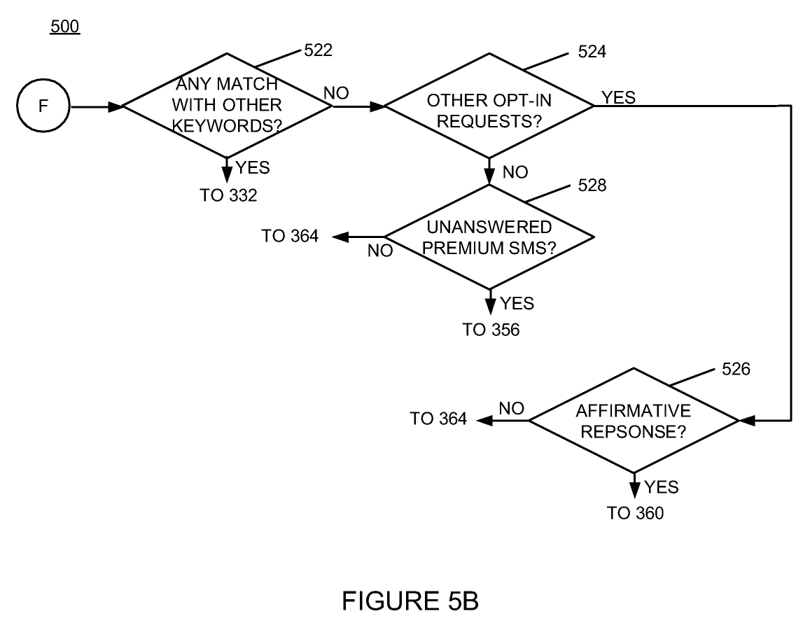

If a determination is made at decision point 326 that the incoming message is not a help message, the process 300 continues to process the incoming message as illustrated within FIG. 3B. Referring to FIG. 3B, the process 300 makes a determination as to whether the incoming mobile message is a mobile response message at decision point 330. If the process determines that the message is a mobile response message, the process 300 processes the response message at block 332. Example processing associated with a response message is illustrated in more detail below beginning with FIG. 4. For purposes of the present description, it is assumed that the response message is processed at block 332 and that the process 300 returns to await a new message at decision point 302.

If a determination is made at decision point 330 that the incoming mobile message is not a mobile response message, the process 300 makes a determination as to whether the incoming mobile message is a chat message at decision point 334. If the process determines that the message is a chat message, the process 300 processes the chat message at block 336. Processing of the chat message includes parsing the message to determine whether the chat was accepted or whether a “block” request was issued. If a block request was issued, the process 300 blocks the mobile number associated with the incoming mobile message and ignores the chat request. If the chat was not blocked, the process 300 checks the mobile message for an opt-in keyword. If a keyword is present and indicates that the chat was accepted, the process 300 creates the chat connection and sends a chat start message to both mobile numbers associated with the chat request. The process 300 may perform additional processing and return to decision point 302 to await a new incoming message.

If a determination is made at decision point 334 that the message is not a chat message, the process 300 makes a determination as to whether the message includes a seat request identifier at decision point 338. A seat request identifier may be used as part of an ordering process for concessions, such as goods and/or services, at a venue, such as a stadium or restaurant. If the message includes a seat request identifier, the process 300 processes the message at block 340. Processing of the message includes parsing the message for a seat number at the venue. The seat number may be saved to the database 208 and a confirmation message is sent to the mobile number associated with the message. The process 300 may perform additional processing and return to decision point 302 to await a new incoming message.

If a determination is made at decision point 338 that the message does not include a seat request identifier, the process 300 makes a determination as to whether the message includes a concession identifier at decision point 342. If the process 300 determines that the message includes a concession identifier, the process 300 processes the message at block 344. A concession identifier may be used as part of a concession ordering process. Several messaging sequences may be used to fulfill a concession order. Alternatively, a single message sequence may be used. Information usable to fulfill a concession order includes payment type, payment confirmation information such as a personal identification number (PIN), seat location if used at a venue, and other information.

At block 344, the process 300 initially processes the message including a concession identifier by parsing the message for a quantity request. If the message includes a quantity request, the process 300 determines whether the mobile number associated with the message is registered with a secure mobile payment service, such as iPayText. If the mobile number is registered, the process 300 sends a message to the mobile number associated with the message requesting a payment type. If the mobile number is not registered, the process 300 sends a message to the mobile number associated with the message requesting the seat location. If the incoming message is a payment type response, the system checks to see if the mobile number is registered. If the number is registered, the process 300 sends a personal identification number (PIN) request message to the mobile number associated with the message and sets an indication, such as a PIN flag, to “true” to allow subsequent routing and processing of incoming messages within the process 300. If the number is not registered, the process 300 sends a seat request message and sets a seat request indicator, such as a seat request flag to “true” to allow subsequent routing and processing of incoming messages within the process 300. The process 300 may perform additional processing and return to decision point 302 to await a new incoming message.

If the process 300 determines that the message does not include a concession identifier at decision point 342, the process 300 makes a determination at decision point 346 as to whether the message includes a PIN associated with an active transaction for the purchase of concessions, such as goods and/or services. If the message includes a PIN, the process 300 processes the PIN at block 348. At block 348, the process 300 parses the message for the PIN and determines whether the PIN is correct.

If the PIN is correct, the process 300 makes a determination as to whether the campaign associated with the message is a concession or payment campaign. An example of a payment campaign is an iPaytext campaign. If the campaign is a concession type campaign, the process 300 sends a seat request message to the mobile number associated with the message and sets the seat request identifier, such as the seat request flag to “true” to allow subsequent routing and processing of incoming messages within the process 300. If the campaign is a payment campaign, such as an iPaytext campaign, the process 300 sends a payment confirmation message to the mobile number associated with the message.

If the PIN is incorrect, the process 300 determines whether this is a first attempt or a subsequent PIN entry attempt. The process 300 may be configured with a threshold tolerance for incorrect PIN entry. For purposes of the present example, it is assumed that this threshold tolerance is one incorrect PIN, such that the account associated with the mobile number is suspended if a second incorrect PIN is received. Continuing with the present example, if it is the first PIN attempt and the PIN is incorrect, the process 300 sends a second PIN request message to the mobile number associated with the message. If this is the second PIN attempt and the PIN is incorrect, the process 300 suspends the account based upon the threshold tolerance for incorrect PIN entry. The process 300 sends a notification message to the mobile number associated with the message indicating that the account was suspended due to excessive inaccurate PIN number entries. The process 300 may perform additional processing and return to decision point 302 to await a new incoming message.

If the process 300 determines that the message does not include a PIN associated with an active transaction for the purchase of concessions, such as goods and/or services, at decision point 346, the process 300 determines whether the message includes a payment flag, such as an iPaytext flag, at decision point 350. If the message includes a payment flag, the process 300 processes the payment at block 352. At block 352, the process 300 parses the message for payment information, such as a numeric quantity, associated with the payment. If payment information is found, the process 300 updates the database 208 with the payment information and sends a PIN request, such as an iPayText PIN request, to the mobile number associated with the message. The process 300 sets a PIN indicator, such as an iPayText PIN flag, to indicate that a PIN response is pending. If payment information is not found with the message the process 300 will send a help message to the mobile number associated with the message. The process 300 may perform additional processing and return to decision point 302 to await a new incoming message.

If the process 300 determines that the message does not include a payment indicator at decision point 350, the process 300 continues to process the incoming message as illustrated within FIG. 3C. Referring to FIG. 3C, if the process 300 determines that the message does not include a payment indicator, the process 300 makes a determination as to whether the message includes a premium short message service (PSMS) indicator, such as a PSMS flag, at decision point 354. If the process 300 determines that the message includes a PSMS indicator, the process 300 processes the message at block 356. At block 356, the process 300 determines whether the message includes an affirmative response to an opt-in request message. If the message includes an affirmative response, the process 300 determines a campaign type associated with the message. If the campaign type includes a one-time premium campaign type, the process 300 sends a premium message to the mobile number associated with the message and bills the account associated with the mobile number. If the campaign is a premium subscription campaign type, the process 300 sets the billing cycle and sends a premium message to the mobile number associated with the message. If the incoming message does not include an affirmative response to an opt-in request message, the process 300 makes a determination as to whether any parameters within the message match any other opt-in keywords. If the message includes any parameters matching other opt-in keywords, the process 300 processes any additional keywords. This may include routing the message back to block 332. If the message does not include any additional opt-in keywords, the process 300 makes a determination as to whether any parameters within the message match any unanswered replies. If the message includes any parameters matching any unanswered replies, the process 300 processes any unanswered replies. This may include routing the message back to another block within the process 300, as described in more detail below in association with a situation where no flags are present within a message (See description of block 364 below). If the message does not include any parameters matching any unanswered replies, the process 300 sends a help message to the mobile number associated with the message.

If the process 300 determines that the message does not include a PSMS indicator at decision point 354, the process 300 makes a determination as to whether the message includes an opt-in indicator, such as an opt-in flag, at decision point 358. If the process 300 determines that the message includes an opt-in indicator, the process 300 processes the message at block 360. At block 360, the process 300 determines whether the mobile number associated with the message has already been opted into a campaign. If the mobile number associated with the message has already been opted into a campaign, a confirmation message is sent to the mobile number. If the mobile number has not been opted into a campaign, the process 300 opts the mobile number into the campaign and sends a confirmation message to the mobile number. The process 300 may perform additional processing and return to decision point 302 to await a new incoming message.

If the process 300 determines that the message does not include an opt-in indicator, the process 300 makes a determination as to whether the message does not include any indicators, such as flags, or whether the message matches any unanswered replies, at decision point 362. If the process 300 determines that the message does not include any indicators or that the message matches any unanswered replies, the process 300 processes the message at block 364. Example processing associated with block 364 is illustrated in more detail below beginning with FIG. 5. For purposes of the present description, it is assumed that the message is processed at block 364 and that the process 300 returns to await a new message at decision point 302.

FIGS. 4A-4B illustrate an example of an implementation of a flow chart for a process 400 for message processing for a response message. The process 400 may form a portion of the mobile messaging campaign application 204 as described within the example of FIG. 3B at block 332. It should be understood that certain of the processing steps within FIGS. 4A-4B are depicted as leaf processes without flow paths illustrated within these figures. The depiction of these processing steps as leaf processes is for ease of illustration purposes only and is not to be considered limiting. Any leaf processing step may perform other operations, continue to other processing steps, and return to await a new incoming mobile message as described above in association with FIGS. 3A-3C without departure from the scope of the present subject matter.

Referring to FIG. 4A, the process 400 makes a determination as to whether a keyword is present at decision point 402. If a determination is made that a keyword is not present, the process 400 sends a help message to the mobile number associated with the message that the message was not recognized at block 404. If a determination is made that a keyword is present, the process 400 loads campaign information and a campaign type associated with the keyword at block 406.

At decision point 408, the process 400 makes a determination as to whether the campaign type associated with the message is a one-time paid campaign. A one-time paid campaign may perform a process of reconfirming that a user of the mobile number wishes to proceed (e.g., a double opt-in confirmation by the end user). If a determination is made that the campaign type is a one-time paid campaign, the process 400 sends a one-time message and charges an account associated with the mobile number for delivery of message at block 410. At block 410, the process 400 also sends a premium one-time confirmation message indicating the campaign cost and sets the premium SMS indicator, such as the PSMS flag, to indicate that a premium one-time campaign is associated with the mobile number.

If a determination is made that the campaign type is not a one-time paid campaign at decision point 408, the process 400 makes a determination as to whether the campaign type associated with the message is a subscription free campaign at decision point 412. A subscription free campaign also performs a process of reconfirming that a user of the mobile number wishes to proceed (e.g., a double opt-in confirmation by the end user) and receive subscription messages. If a determination is made that the campaign type associated with the message is a subscription free campaign at decision point 412, the process 400 makes a determination as to whether the mobile number is already opted into the mobile campaign at decision point 414. If a determination is made at decision point 414 that the mobile number is not already opted into the mobile campaign, the process 400 sends a double opt-in request message indicating campaign information and sets the opt-in indicator, such as the opt-in flag, to indicate that the mobile number is opted into the campaign at block 416. If a determination is made at decision point 414 that the mobile number is already opted into the mobile campaign, the process 400 sends a confirmation message to the mobile number associated with the message at block 418.

If a determination is made that the campaign type associated with the message is not a subscription free campaign at decision point 412, the process 400 makes a determination as to whether the campaign is a subscription paid campaign at decision point 420. A subscription paid campaign also performs a process of reconfirming that a user of the mobile number wishes to proceed (e.g., a double opt-in confirmation by the end user) and receive subscription messages. The process 400 additionally bills an account associated with the mobile number with a recurring fee to receive subscription messages. The recurring fee may be pre-set by agreement with the user of the mobile number. If a determination is made that the campaign type associated with the message is a subscription paid campaign at decision point 420, the process 400 makes a determination as to whether the mobile number is already opted into the mobile campaign at decision point 422. If a determination is made at decision point 422 that the mobile number is not already opted into the mobile campaign, the process 400 sends a premium subscription confirmation message indicating the campaign information and cost at block 424. At block 424, the process 400 also sets a premium SMS indicator, such as the premium SMS flag, to indicate that a premium SMS campaign is associated with the mobile number. If a determination is made at decision point 414 that the mobile number is already opted into the mobile campaign, the process 400 sends a confirmation message to the mobile number associated with the message at block 418.

If a determination is made that the campaign type associated with the message is not a subscription paid campaign at decision point 420, the process 400 continues to process the incoming message as illustrated within FIG. 4B. Referring to FIG. 4B, the process 400 makes a determination as to whether the campaign is a one-time free campaign at decision point 426. A one-time free campaign provides for a single opt-in request associated with a mobile number to allow that mobile number to receive a message. If a determination is made that the campaign is a one-time free campaign, the process 400 sends the message to the mobile number at block 428.

If a determination is made that the campaign type associated with the message is not a one-time free campaign at decision point 426, the process 400 makes a determination as to whether the campaign is a mobile payment service campaign, such as an iPayText campaign, at decision point 430. A mobile payment service campaign allows a user associated with a mobile number to request and authenticate a purchase of concessions, such as goods and/or services, by linking the purchase to the user's credit card. If a determination is made that the campaign is a mobile payment service campaign, the process 400 makes a determination as to whether mobile number is registered at decision point 432. If a determination is made that the mobile number is registered, the process 400 sends a quantity request message to mobile number and sets a payment indicator, such as the iPayText flag, to indicate that the quantity request message has been sent to this mobile number at block 434.

If a determination is made that the campaign is not registered at decision point 432, the process 400 sends a registration request message to the mobile number indicating that an account has not been established and provides instructions for registering with an account creation service online or otherwise to create an account at block 436. An account may include an iPayText account or other type of payment account.

If a determination is made that the campaign is not a mobile payment service campaign at decision point 430, the process 400 makes a determination as to whether the campaign is a mobile concession ordering campaign, such as an iConcession campaign, at decision point 438. A mobile concession ordering campaign allows a mobile number to initiate a request for concessions and to pay for concessions at a venue using an account associated with the mobile number. If a determination is made that the campaign is a mobile concession ordering campaign, the process 400 sends a quantity request message to the mobile number and sets a concession flag to indicate that the quantity request message has been sent to the mobile number at block 440.

If a determination is made that the campaign is not a mobile concession ordering campaign at decision point 438, the process 400 makes a determination as to whether the campaign is a chat campaign, such as a text-to-chat campaign, at decision point 442. If a determination is made that the campaign is not a chat campaign, the process 400 sends a help message to the mobile number at block 444. If a determination is made that the campaign is a chat campaign, the process 400 makes a determination as to whether the mobile number is registered at decision point 446. A mobile number may be considered registered once it has its mobile number and a unique user name defined within a chat table stored in the database 208. If a determination is made that the mobile number is registered, the process 400 validates a user name associated with the mobile number in a chat table, sends a chat request to a second mobile number associated with the intended recipient of the chat request, and either waits for the second mobile number to accept a chat request at block 448 or returns to decision point 302 to await receipt of a message from the second mobile number indicating that the chat request has been accepted. At block 448, the process 400 also sends a confirmation to the original mobile number indicating that the chat request has been sent to the second mobile number.

If a determination is made that the mobile number is not registered at decision point 446, the process 400 saves the mobile number to the chat table within the database 208 and sends a user name request message to the mobile number at block 450. The user name request message allows the end user of the mobile number to create a unique user name. At block 450, the process 400 also sets the chat flag to indicate that the user name request message has been sent.

As described above, any leaf step within the process 400 may perform other operations, continue to other processing steps, and return to await a new incoming mobile message as described above in associations with FIGS. 3A-3C without departure from the scope of the present subject matter.

FIGS. 5A-5B illustrate an example of an implementation of a process 500 for message processing for a message that does not include any indicators or that matches unanswered replies. The process 500 may form a portion of the mobile messaging campaign application 204 as described within the example of FIG. 3C at block 364. Referring to FIG. 5A, the process 500 loads a campaign identifier associated with an open message thread linked to the mobile number at block 502. At block 504, the process 500 loads all possible reply options for the associated campaign identifier. At decision point 506, the process 500 makes a determination as to whether the message matches one of the possible reply options. If a determination is made that message matches one of the possible reply options, the process 500 loads the reply option message and sends it to the mobile number at block 508. At block 510, the process 500 makes a determination as to whether the campaign has a “next action” message thread associated with the campaign. A next action message thread indicates a next message to be sent based upon the current message. If a determination is made that the campaign has a next action message thread, the process 500 loads the next action thread message and sends it to the mobile number at block 512.

If a determination is made that the campaign does not have a next action message thread at decision point 510, the process 500 makes a determination as to whether a reply type for the mobile campaign indicates that the thread should be closed at decision point 514. If a determination is made that the thread should be closed, the process 500 closes the current thread at block 516. If a determination is made that the thread should not be closed at decision point 514, the process 500 makes a determination as to whether the mobile number has answered all possible reply options at decision point 518. If a determination is made that the mobile number has answered all possible reply options, the process 500 closes the current thread at block 516. If a determination is made that the mobile number has not answered all possible reply options at decision point 518, the process 500 sends a help message to the mobile number at block 520 and returns to decision point 302 to await receipt of a new message.

If a determination is made that message does not match one of the possible reply options at decision point 506, the process 500 continues to process the incoming message as illustrated within FIG. 5B. Referring to FIG. 5B, the process 500 makes a determination as to whether the message matches any other campaign keywords at decision point 522. If a determination is made that the message matches any other campaign keywords, the process 500 transitions to block 332 in FIG. 3B and operates as described above. If a determination is made that the message does not match any other campaign keywords at decision point 522, the process 500 makes a determination as to whether the message has any other opt-in requests that are awaiting confirmation at decision point 524. If a determination is made that other opt-in requests are awaiting confirmation, the process 500 parses the message further to make a determination as to whether the message includes an affirmative response (e.g., yes, y, ok, sure, buy, etc.) to an outstanding opt-in request at decision point 526. If a determination is made that the message includes an affirmative response to an outstanding opt-in request, the process 500 transitions to block 360 in FIG. 3C and operates as described above. If a determination is made that the message does not include an affirmative response to an outstanding opt-in request at decision point 524, the process 500 transitions to block 364 in FIG. 3C and operates as described above to perform default message processing.

If a determination is made at decision point 524 that there are not any other opt-in requests awaiting confirmation, the process 500 makes a determination as to whether there are any unanswered premium SMS request messages at decision point 528. For example, the process 500 may check a mobile messaging sent table within the database 208 to determine whether there are any unanswered premium SMS request messages. If a determination is made that there are unanswered premium SMS request messages, the process 500 transitions to block 356 in FIG. 3C and operates as described above to process premium SMS messages. If a determination is made that there are no unanswered premium SMS request messages at decision point 528, the process 500 transitions to block 364 in FIG. 3C and operates as described above to perform default message processing.

The foregoing description of an implementation has been presented for purposes of illustration and description. It is not exhaustive and does not limit the claimed inventions to the precise form disclosed. Modifications and variations are possible in light of the above description or may be acquired from practicing the invention. For example, persons skilled in the art will understand and appreciate, that one or more processes, sub-processes, or process steps described in connection with FIGS. 1 through 5B may be performed by hardware and/or software. Additionally, a mobile messaging system, as described above, may be implemented completely in software that would be executed within a processor or plurality of processors in a networked environment. Examples of a processor include but are not limited to microprocessor, general purpose processor, combination of processors, DSP, any logic or decision processing unit regardless of method of operation, instructions execution/system/apparatus/device and/or ASIC. If the process is performed by software, the software may reside in software memory in the device used to execute the software. The software in software memory may include an ordered listing of executable instructions for implementing logical functions (i.e., “logic” that may be implemented either in digital form such as digital circuitry or source code or optical circuitry or chemical or biochemical in analog form such as analog circuitry or an analog source such an analog electrical, sound or video signal), and may selectively be embodied in any signal-bearing (such as a machine-readable and/or computer-readable) medium for use by or in connection with an instruction execution system, apparatus, or device, such as a computer-based system, processor-containing system, or other system that may selectively fetch the instructions from the instruction execution system, apparatus, or device and execute the instructions. In the context of this document, a “machine-readable medium,” “computer-readable medium,” and/or “signal-bearing medium” (herein known as a “signal-bearing medium”) is any means that may contain, store, communicate, propagate, or transport the program for use by or in connection with the instruction execution system, apparatus, or device. The signal-bearing medium may selectively be, for example but not limited to, an electronic, magnetic, optical, electromagnetic, infrared, or semiconductor system, apparatus, device, air, water, or propagation medium. More specific examples, but nonetheless a non-exhaustive list, of computer-readable media would include the following: an electrical connection (electronic) having one or more wires; a portable computer diskette (magnetic); a RAM (electronic); a read-only memory “ROM” (electronic); an erasable programmable read-only memory (EPROM or Flash memory) (electronic); an optical fiber (optical); and a portable compact disc read-only memory “CDROM” “DVD” (optical). Note that the computer-readable medium may even be paper or another suitable medium upon which the program is printed, as the program can be electronically captured, via, for instance, optical scanning of the paper or other medium, then compiled, interpreted or otherwise processed in a suitable manner if necessary, and then stored in a computer memory. Additionally, it is appreciated by those skilled in the art that a signal-bearing medium may include carrier wave signals on propagated signals in telecommunication and/or network distributed systems. These propagated signals may be computer (i.e., machine) data signals embodied in the carrier wave signal. The computer/machine data signals may include data or software that is transported or interacts with the carrier wave signal. Note also that the implementation may vary between systems. The claims and their equivalents define the scope of the invention.

What is claimed is:

1. A method comprising:
establishing a mobile messaging campaign to process bidirectional mobile campaign messages associated with each of a plurality of mobile numbers using a single short code;
receiving a mobile message associated with the mobile messaging campaign;
parsing the received mobile message to extract a campaign identifier; and
processing the received mobile message based upon the campaign identifier.

2. The method of claim 1 where establishing the mobile messaging campaign further comprises selecting a mobile campaign type associated with the mobile messaging campaign, where the mobile campaign type is selected from a group consisting of a mobile alert campaign type, a trivia campaign type, a text-to-win campaign type, a text-to-vote campaign type, a text-to-chat campaign type, and an interactive campaign type.

3. The method of claim 1 where establishing the mobile messaging campaign further comprises establishing a premium service associated with the mobile messaging campaign.

4. The method of claim 1 where establishing the mobile messaging campaign further comprises sending a message to at least one of the plurality of mobile numbers using the single short code, and receiving the mobile message associated with the mobile messaging campaign further comprises receiving the mobile message in response to sending the message.

5. The method of claim 1 further comprising parsing the received mobile message to extract an opt-in response, and where processing the received mobile message based upon the campaign identifier further comprises establishing a reply thread when the opt-in response is affirmative.

6. The method of claim 5 further comprising sending a confirmation message to a mobile number associated with the received mobile message requesting confirmation of the opt-in response.

7. The method of claim 1 where processing the received mobile message based upon the campaign identifier further comprises processing the mobile message in association with a reply thread.

8. The method of claim 1 where processing the received mobile message based upon the campaign identifier further comprises processing a mobile payment.

9. The method of claim 1 further comprising parsing the received mobile message to extract a concession order and where processing the received mobile message based upon the campaign identifier further comprises processing the concession order.

10. The method of claim 9 where processing the concession order further comprises processing seat information associated with the concession order.

11. A system comprising:
a mobile messaging campaign application adapted to:
establish a mobile messaging campaign to process bidirectional mobile campaign messages associated with each of a plurality of mobile numbers using a single short code;
receive a mobile message associated with the mobile messaging campaign;
parse the received mobile message to extract a campaign identifier; and
process the received mobile message based upon the campaign identifier; and
a processor adapted to execute the mobile messaging campaign application.

12. The system of claim 11 further comprising a database for storing mobile message campaign information.

13. The system of claim 12 wherein the mobile messaging campaign application is further adapted to generate the mobile message campaign information based upon the established mobile messaging campaign and the processor is further adapted to store the mobile message campaign information to the database.

14. The system of claim 11 where the mobile messaging campaign application is further adapted to select a mobile campaign type associated with the mobile messaging campaign, where the mobile campaign type is selected from a group consisting of a mobile alert campaign type, a trivia campaign type, a text-to-win campaign type, a text-to-vote campaign type, a text-to-chat campaign type, and an interactive campaign type.

15. The system of claim 11 where the mobile messaging campaign application is further adapted to establish a premium service associated with the mobile messaging campaign.

16. The system of claim 11 where the mobile messaging campaign application is further adapted to send a message to at least one of the plurality of mobile numbers using the single short code and to receive the mobile message in response to sending the message.

17. The system of claim 11 where the mobile messaging campaign application is further adapted to parse the received mobile message to extract an opt-in response and to establish a reply thread when the opt-in response is affirmative.

18. The system of claim 17 where the mobile messaging campaign application is further adapted to send a confirmation message to a mobile number associated with the received mobile message requesting confirmation of the opt-in response.

19. The system of claim 11 where the mobile messaging campaign application is further adapted to process the mobile message in association with a reply thread.

20. The system of claim 11 where the mobile messaging campaign application is further adapted to process a mobile payment.

21. The system of claim 11 where the mobile messaging campaign application is further adapted to parse the received mobile message to extract a concession order and to process the concession order.

22. The system of claim 21 where the mobile messaging campaign application is further adapted to process seat information associated with the concession order.
